(19) United States
(12) Patent Application Publication
(10) Pub. No.: US 2016/0136853 A1
(43) Pub. Date: May 19, 2016

(54) THERMOPLASTIC POLYMER FORMULATION CONTAINING RECYCLED POLYOLEFINS AND METHOD OF PREPARING

(71) Applicant: IGAP S.P.A., Viadana (MN) (IT)

(72) Inventor: Giuseppe DINUNZIO, Viadana (MN) (IT)

(73) Assignee: IGAP S.P.A., Viadana (MN) (IT)

(21) Appl. No.: 14/777,566

(22) PCT Filed: Mar. 19, 2014
(86) PCT No.: PCT/EP2014/055470

§ 371 Date: Sep. 16, 2015

(30) Foreign Application Priority Data
Mar. 19, 2013 (IT) MI2013A000420
Oct. 10, 2013 (EP) 13188171.6

(51) Int. Cl. B29C 45/00; C08K 3/22; B29C 47/78; C08L 23/06; B29C 45/72; B29C 47/00; C08K 3/26; C08L 23/12

(52) U.S. Cl. CPC B29C 45/0001; C08K 3/26; C08K 3/22; C08L 23/12; C08L 23/06; B29C 45/72; B29C 47/0004; B29C 47/78; C08K 2003/265; C08K 2003/2206; C08K 2003/222; C08K 2003/2227; C08K 2003/2296; B29K 2105/26

(57) ABSTRACT

Recycling of polyolefin materials from packaging materials, in particular food packaging, is carried out by treating the polyolefin material with at least one metal oxide such as CaO. The final extruded or injection molded product is free from bad smell.

### BACKGROUND OF THE INVENTION

The present invention refers to a thermoplastic polymer formulation containing recycled polyolefins and to a method of preparing such formulation. In particular, the invention refers to a thermoplastic formulation containing recycled polyolefins, comprising at least one polypropylene (PP), and at least one polyethylene (PE), in combination with metal oxides and/or hydroxydes; preferably with at least one of CaO, MgO, Al₂O₃, ZnO and/or at least one of their hydroxydes.

The present invention also relates to the use of at least one of CaO, MgO, Al₂O₃, ZnO in the process of recycling polyolefins as a drying agent, as a deodorant and as a biocidal agent.

More particularly, the present invention refers to a thermoplastic formulation where at least one polypropylene PP and at least one polyethylene PE derive from one or more of the following sources: a) from separate collection of industrial waste deriving from the production of polyolefin films, containers and packaging, or having a predominant polyolefin content, carried out directly in the production places, b) from the separate collection of waste coming from polyolefin films, packagings and containers, or having a predominant polyolefin content, carried out in logistic and distribution centers, at the end of the use of the above mentioned materials; c) from the collection of the waste generated from polyolefin films, packagings and containers, or having a predominant polyolefin content, carried out in the centers for the separate collection of waste resulting from the processes of end use, e.g. from urban (polymeric) garbage. The latter is by far the predominant source of PP/PE recycled polymers; although the process of separate claim and collection of this kind of garbage is structured according to different national laws or rules, it is becoming more and more differentiated, and therefore more and more accurate.

### DESCRIPTION OF THE KNOWN ART

Films, packagings and containers, are usually made of polyolefins. Since long, polyolefin packages and packaging, containers and films have been increasingly subjected to separate collection; regenerated polyolefins are obtained from recycling processes whereby, in fact, it is possible to achieve highly homogeneous materials, in terms of chemical formulation. The best known case is still that of garbage bags. Regenerated polymeric compounds, in form of flakes or granules, obtained from the collection of polyolefin packagings, containers, films (PP only, PE only, coupled PP-PE, co-extruded PP-PE) are available on the market, wherein both PP and PE are present in different forms, at high and/or low density, and which are characterized by a complex and inhomogeneous formulation. As a matter of fact, the process of industrial regeneration of the product of separate collection, comprising the steps of grinding, washing, flotation, centrifugation (followed by extrusion and granulation process, if a granule is needed), cannot achieve, in economically sustainable terms, or due to technical impossibility, a fine and homogeneous separation of all different polyolefins present in recycling. Two facts have further contributed to make more complex the formulation and structure of regenerated compounds, in flake or granule, so far described.

On one hand, new polymer families have found an increasing use in production of films, packagings and containers in different industrial fields, or as an aid to processes of distribution and fast-moving consumer goods, in a progressively increasing specialization. PVC is used in the production of containers and packagings for cosmetics, confectionery, fruit juices, pharmaceutical, cloth and tarpaulin industries and of medical products; PVdC is used in the production of packagings and containers for highly spiced, dried, dehydrated foods, cured meats, meat, fish, meat, dairy products, sweets. Styrene polymers are used in the production of packagings and containers for perishable foods, in the form of PS; in the production of industrial packagings, in the form of ABS; in the production of packagings, containers and as fillers for packaging and containers, in the form of EPS. A source of plastic materials to be recycled according to the present invention are the materials used for food packaging and garbage bag containers, i.e. polyolefin plastics that are contaminated by organic materials (e.g. food residues) deriving from the content of the packaging.

Generally, PVC, PVdC and styrene polymers are considered to be only partially compatible with PP and PE, in the combined re-use in industrial processes, particularly of extrusion; over time a combined separate collection of packagings, films, containers has been established that comprises, besides those made by polyolefins, those produced with PVC, PVdC, and styrene polymers.

On the contrary PET, which is as well subjected to combined separate collection of b) and c) types so far described, is always separated from other polymer families, before carrying out the industrial regeneration processes, because of the recognized incompatibility thereof in the combined re-use with other recycled polymers in thermoplastic industrial processes. Finally, polyamides (PA), particularly used in the production of multi-layer films with PP or PE, or both, are subjected to collection with the polymer families listed above, only if they are not technically separable, or if their separation costs are too high. In these last two cases, before the processes of industrial regeneration, the PAs, or the films containing also PA, are separated, in view of the recognized highly incompatibility in a combined reuse with other thermoplastic polymers. Usually, waste containing PA is burned for energy cogeneration.

Therefore, as far as technologically possible and affordable, the primary object of the industrial regeneration processes following a separate collection of polymer packaging, containers and films is to recover the single polymer families, or even the single polymer types present in a separate and homogeneous form.

Until now such an object has been peremptorily fulfilled with regard to PET and PA (PET being more easily separable than PA from the other polymer types), due to the high incompatibility of both of them in the combined reuse in thermoplastic processes, with a combustion end-use of mixed and not separable waste that contains PA.

For the other polymer families, as far as it is technically simple or compatible with available regeneration technologies, and at the same time economically profitable, the separation of the described waste and garbage is carried out before the industrial regeneration, at least for homogeneous families. However, increasing quantities of recycled material deriving from combined recycling collection processes of the described types are offered on the market, with the coexistence of polyolefins in predominant percentage amounts, of PVC, PVdC, styrene polymers, also in not negligible amounts and, possibly, only traces of polyamide PA and PET, so that the reuse in thermoplastic processes of the regenerated compound in form of flakes or granules is not jeopardized.

The coexistence of significant percentages of other different polymer families together with polyolefins coming from recycled packagings has to be accepted, (except for PET and PA), in order to make available a polymer flake or granule from recycling at competitive costs with respect to virgin polyolefins. This is true particularly for the PP, for the manufacturing of low-cost products, usually coming from the use of regenerated compounds in extrusion processes.

Such regenerated compounds, which maintain a prevalent polyolefin content, but comprise as well the other polymer families set forth above, as a flake or granule, are commercially available at a price ranging from 0.30 to 0.60 euro/kg. More expensive regenerated compounds have higher polyolefin content and simpler and more homogeneous structure; in fact, as can be understood, the more challenging are the separation and purification processes, the higher is the production cost of the regenerated compounds themselves. As a consequence, such regenerated compounds in form of flake or granule are clearly competitive with respect to the virgin PP.

The commercial name of the above described regenerated compounds containing only, or mainly, polyolefins, still has not an unanimous recognition on the market. However, the definition “polyolefin flake or granule from recycled packaging” is more and more used, also in case where the polyolefin content is not exclusive, but only prevalent. In such a way they will be defined in this description, even though the polyolefin content will not be exclusive, in order to identify this polymer compound. The term “polyolefin material” used in the following description indicates a thermoplastic polymer material that, as defined below, contains at least 80 wt % of PP and PE, preferably 94-98 wt %, and a maximum of 1.0 wt % of PA and PET each.

In addition to the above definition, also the GS abbreviation, followed by a number, is being used, at least in Italy, to identify the recycled poliolefins, e.g. ad products GS1, GS2, GS3, etc. An increasing number corresponds to an increasing cost, since the number increase corresponds to a higher polyolefin content and to a more homogeneous structure of the regenerated compound.

Polyolefin flakes and granules from recycled packaging are getting a growing application in extrusion processes for the manufacture of low-cost products, without a real aesthetic value, that do not require significant technical performances in terms of capacity in the three spatial directions, impact resistance, use fatigue. Examples of these products are plates, rods, frames, sections, elements for fixtures not aimed to load-bearing, and elements for external paving, as well as agriculture and construction industry products, such as tubes, irrigation tubes, sheaths, raceways, spacers. In these processes, the polyolefin flakes or granules are used alone, or mixed with virgin polyolefins. Co-extrusion applications together with wood fiber and powder, which are well compatible with GS compounds, mixed with virgin polyolefins, are already known with reference to extrusion processes.

Polyolefin granules from recycling are used as well in the injection molding processes of products without the requisite of aesthetic value on surfaces such as, e.g., perforated tiles for paving of green areas and parkings, flower boxes and vases, dustbins and waste containers, and pallets.

Polyolefin granules from recycled packaging, as described thus far, are only used as excipients, in the range 5-8 wt %, within polymer mixtures that for the remaining 92-95% are made of virgin polyolefins, for the injection moulding production of products requiring an aesthetic and/or structural feature. Products requiring aesthetic features, are those with surfaces that should present high aesthetic requirements relative to the compactness and uniformity of the surface. Products with structural requirements are those that should fulfill stringent technical requisites, such as the technical-aesthetic components suitable to provide translation and rotation movements, providing joints and assemblies, also with the use of hardware of different parts, and/or which should present significant capacity properties, impact resistance, fatigue resistance according to the type of use.

Moreover, generally, applications of polyolefin granules or flakes coming from recycled packaging are not known, even as a part of a polymer formulation or composition, for customer goods, fast-moving customer goods and for products intended for the use in closed and not aerated places.

This last serious limitation is due to the really strong and bad smell coming from polyolefin granules or flakes derived from recycled packagings, during the process of regeneration, reextrusion and regranulation, and during injection molding, at the temperatures of use thereof; this smell persists with the products also after the end of the cooling, shrinkage, and crystallization processes, and lasts also after a manufactured product is exposed and kept outdoors for prolonged period in good ventilation conditions. Such drawback is present also when using small amounts of polyolefin granules from recycled packagings together with granules from virgin polyolefins. This foul smell derives in particular from the presence of residues of organic waste materials in the materials obtained from garbage sources, such as used containers and packaging for food, garbage bags and similar materials. Plastics waste contaminated by organic materials has to be subjected to a number of operations before it is suitable for granulation or pelletization, such as crushing, shredding, sorting, washing, dewatering and drying.

However, the smell remains in these materials after they have been washed and treated to be ready for granulation and dramatically increases during both extrusion and injection molding; as mentioned, the smell persists in the moulded products. In fact, the extrusion and injection-molding products containing recycled polyolefin granules are presently intended for the production of elements which are usually placed in outdoors areas, such as vases and flower boxes or which are intended to contain smelly materials such as dustbins and garbage containers.

In the following description the wording “polyolefin material from recycled packaging” is used to mean plastics waste contaminated by organic materials as above discussed.

An additional problem in the use of recycled polyolefins, particularly from recycled packaging, is related to the fact that the variability and poor consistency of the formulation contained within the regenerated granule or flake, oppose to the achievement of aesthetically acceptable surfaces and constant technical features of the final products. At the same time, the use of said granules in injection molding processes is limited or prevented by the extreme softness, or gumminess, of granules or flakes obtained from recycling; the gumminess is associated with fragility, that increases with the complexity of the formulation of the regenerated compound, and with a melting flow index MFI problematic for an efficient molding, which is generally very low.

The problems listed so far have been verified, and their presence ascertained by the applicant, by extensively testing the polyolefin granules or flakes from recycled packaging both alone, i.e. without mixing with other polymer components, and in polymer mixtures at percentages comprised between 5-8 wt %, wherein the remaining part was constituted by virgin polyolefins. The used PP and PR polyolefins from recycling have been tested both alone and in association with other recycled polymers such as, PVC, PVdC, and styrene polymers.

Target products of the molding industrial tests mainly belonged to indoor and outdoor furniture types, such as chairs, tables, armchairs, deck chairs, food carts, closed and open elements for the storage of household products and tools, toys and cabins for parks and gardens. The tests confirmed the impossibility to successfully realize a molding process, i.e. to obtain aesthetically acceptable products, provided with the technical requisites of capacity, stress, impact, and wear resistance that are required to obtain the desired certifications of products for domestic, and/or collective use, based on the European UNI-EN regulations.

At the same time, it was found impossible to obtain from said formulations technical components, such as joints and hinges, provided with minimal requisites of rigidity, stability and wear resistance required to undergo translations and/or rotation movements. In all tests realized, one or more of the highlighted problems have been found, as soon as the polyolefin granules or flakes from recycled packaging were used alone. In several cases, even the simple presence of excipients, such as 5-8 wt % of a recycled mixture where the remaining part was made by virgin polyolefins, showed the presence of one or more of the above listed problems. For example, in all molding tests, molding operators were obliged to wear protective masks in order to neutralize the effects of the sickly and pungent smell released at the working temperatures of the injection molding processes; in all tests said smell was found to be present in manufactured products, at levels which are not compatible with the consumer goods nature of the invention products.

WO2005080060 discloses a method and an apparatus for treating plastic waste materials, in which the plastic is heated and the vapours are filtered to remove the smell. Also, an expensive plasma treating of the plastic surfaces was carried out to remove the smell.

It is an object of the present invention to solve the above listed problems and to obtain, starting from the recycling of PP- and PE-based packaging materials, polyolefin-based polymer mixtures in all possible forms, including low density and high density polymers, wherein PP and PE could be efficiently used in the injection molding processes. Further object of the invention is to obtain polymer mixtures suitable for molding, particularly injection molding, at more competitive costs with respect to those achievable with the use of virgin polypropylene, or virgin polypropylene charged with CaCO₃ mineral filler.

In particular, an object of the present invention is to obtain polymer mixtures that can be used for the production of tables, chairs, armchairs, furniture products in general for indoors and outdoors and for automotive elements such as door panels, dashboards and outer panels, that are characterized by surfaces with aesthetic value, and that are able to express all technical and functional features necessary to achieve the certifications for the domestic and/or collective use according to the European technical regulations UNI EN.

Still an object of the invention is to provide an efficient way of recycling the mentioned recycled contaminated plastic material from packaging and in particular from food packaging and from garbage. Therefore, an object of the invention is a method of preparing a formulation according to claim 10 and a method of recycling plastic according to claim 20.

### SUMMARY OF THE INVENTION

The research activity in the field carried out by the applicant allowed to provide a set of solutions, as final mixtures intended for the injection molding process, and of methods for their treatment preliminary to the molding step, the mixtures and methods showing to be effective regarding the proposed objects, and economically efficient, because they are competitive with respect to costs of production and treatment of traditional mixtures based on virgin polyolefins, and in particular of virgin PP, and virgin PP with CaCO₃ mineral filler.

The results are obtained preferably with the proviso that the polyolefin granule or flake from recycled packaging have a weight percentage content of PP and PE polyolefins components, in the different forms in which they can be found, at least equal to 80% of the total weight of the used granule or flake (with a preferred average content found in the tested samples of 93% of the total weight); that the polyamides PA from recycled films and packaging are absent, or in any case not present at a content higher that 1 wt %; that PET from recycled containers is absent, or present at a content not higher than 1 wt %; whereas PVC, PVdC, styrene polymers are not present at a content higher than 20 wt % (with a preferred average content found in the tested samples of 5% of the total weight).

Generally, therefore, the invention refers to a polymer composition or formulation according to claim 1, comprising the following weight amounts relative to the total weight of the formulation:
0.1% to 10%, preferably 0.1% to 8.0% of a metal oxide selected from at least one of CaO, MgO, Al₂O₃, ZnO, more preferably CaO, generally in the form of a compound, i.e. a plastic matrix containing the mentioned oxide(s). The amount of this compound is in the range of 0.5 wt % to 20 wt % relative to the total weight of the formulation; in lieu of the above oxides, the corresponding products obtained by reaction of said oxides with water can be present as a result of the preparation process, also a combination of oxides and hydroxides can be present. In any case the total amount of oxides and hydroxides, expressed as amount of oxides by weight on the total mixture, is in the previously mentioned range of 0.1% to 10%, preferably 0.1% to 8.0% by weight.
0-25% of mineral filler selected from CaCO₃, talc, glass fiber, wood, whereby the maximum amount of wood is 20% by weight or less,
8.0-99.5%, preferably 10-99.5%, more preferably 15-99.5% of polyolefin material from recycled packaging, without fillers,
wherein said polyolefin material comprises at least 80 wt % of PP and/or PE, a PA amount between 0 and 1.0% and a PET amount between 0 and 1.0%;
possible further polyolefin materials not from recycled packaging up to 100% by weight.

The formulation may be in the form of chips or scales and pieces of polyolefin material in a mixture with the remaining components; in another embodiment the formulation is as granules or pellets containing the claimed metal oxides and possibly some hydroxides; in another embodiment the formulation is in the form of granules/pellets in which the majority of the oxides has reacted with water during e.g. the preparation of the granules or pellets of the invention. The latter formulation contains the hydroxides of the claimed metal oxides and is ready for injection molding.

Another product of the invention is a molded product obtained by extrusion or injection molding of the mentioned granules or formulation, i.e. a molded product according to claim 16. A non-limiting list of exemplary molded products according to the invention is recited in claim 17.

As better discussed hereinafter, the above mentioned metal oxides are present in the formulation before it is heated and subjected to hot melt treatments such as extrusion and/or injection molding; extrusion may be carried out to provide granules or pellets for a subsequent molding step, or to provide an extrusion-molded product. The metal oxides act as drying agents and react with the water, i.e. as water scavengers, that is present within the recycled polymeric material, even if the said material was dried according to known methods; by reaction with water, the oxides are transformed into the corresponding hydroxydes, eg. Ca(OH)₂, Mg(OH)₂, Al(OH)₃ etcetera. If there is less water than oxide (or oxides if more than one oxide is used), the final formulation will contain both hydroxide(s) and some remaining oxide(s). The mentioned oxides are most preferably added to the recycled polymers in the form of a compound of granules or pellets of polymeric material (usually PP or PE) in which the metal oxides are dispersed. The compound is dispersed into the polymeric material during the heat treatment; when the temperature is high enough, such as during extrusion molding and injection molding when the polymers are plasticized and melted, the oxides are released into the recycled polymer and are mixed with it by the screw of the processing apparatus to obtain a uniform dispersion of the oxides in the formulation.

The resulting hydroxydes are similarly dispersed into the polymer material and “sealed” by said material against further reaction, e.g. from reacting with atmospheric gases to become carbonates.

The invention provides three exemplary families of formulations useful in the implementation of the injection molding processes to obtain aesthetically acceptable products, intended for large-scale use, characterized by technical and functional requisites suitable to fulfill the certifications for domestic and/or collective use, according to the European technical regulations UNI EN, for the different fields.

The three formulation families share a common feature, i.e. the presence in the mixture to be used in the injection molding process, of at least one of CaO, MgO, Al₂O₃, ZnO and/or of their hydroxydes, preferably calcium oxide, CaO, or its hydroxide. The oxides can be introduced into the final mixture in the specific form of drying compounds based on calcium oxide and/or on any of the other oxides dispersed in a polymer matrix that is dispersed in the polymer formulation.

It was found that by adding at least one of CaO, MgO, Al₂O₃, ZnO, preferably CaO and MgO, most preferably CaO, to the materials to be recycled according to the above mentioned formula, it is possible to remove completely, or substantially completely, and permanently, the bad smell typical of the processed plastic materials contaminated by organic waste materials, such as material deriving from recycled food packaging. Additionally, the above oxides perform the drying of the plastic materials and are thereby transformed into the corresponding hydroxydes.

Therefore it is an object of the invention a polymer formulation as above defined, that contains at least one of CaO, MgO, Al₂O₃, ZnO and/or at least one of their hydroxydes.

The present invention relates to a polymer formulation according to claim 1. More particularly, the polymer mixture has a weight percentage amount of the PP and PE polyolefin components, in the different forms they display, equal to at least 80% of the total weight of the mixture, a maximum content of PA polyamides of 1 wt % relative to the total weight of the mixture, a maximum PET content of 1 wt % relative to the total weight of the mixture, a maximum PVC, PVdC, and styrene polymers content equal to 20%; according to the invention, said mixture further contains a drying agent, preferably CaO, at an amount between 0.1 and 8.0%, more preferably between 0.4 and 4.8 wt % relative to the total weight of the mixture. The term “polyolefin material” used in the following description is meant to define a thermoplastic polymer material that, as defined below, contains at least 80 wt % of PP and PE, and a maximum of 1.0% of PA and PET, each.

Preferably said drying agent is selected from at least one of CaO, MgO, Al₂O₃, ZnO, preferably is from CaO and MgO, more preferably is CaO. Preferred amounts of CaO or oxides are between 0.1 wt % and 10.0% preferably 0.1 wt % to 8.0 wt %, more preferably between 1.0 wt % and 4.8 wt % relative to the total weight of the formulation; additional suitable amounts are, e.g., 0.4%, 0.5%, 1%, 1.5%, 2.4%, 4.8% and the intervals defined between said values or combinations thereof. In the final formulation, i.e. after heat treatment and molding step, the total amount of any remaining oxides and of hydroxydes, expressed as metal oxides, is within the ranges here above disclosed.

More generally, the present invention refers to a thermoplastic polymer composition or formulation, in particular polyolefin-based, under the form of granules or other similar products for the manufacturing of a product, i.e. under the form of a product obtained by molding of the formulation, containing a metal oxide, preferably CaO, as a water scavenger and a smell scavenger. The claimed oxide removes water from the polymer material, not only form its surface and suppresses the smell; it is believed that this occurs also because the Nitrogen containing molecules responsible for the smell are somehow bound by the Metal oxides and/or by their corresponding xydroxides. It is a further object of the invention a moulded or extruded product i.e. a manufactured article containing at least one of the hydroxydes deriving from reaction with water of at least one of CaO, MgO, Al₂O₃, ZnO. As an example such an hydroxide is Ca(OH)₂; a combination of both hydroxydes and oxides is possible. The material of the polyolefin formulation is preferably, but not necessarily, a material from recycling, particularly from recycled packaging; alternatively it can be a virgin material wherein at least one of CaO, MgO, Al₂O₃, ZnO, preferably is from CaO and MgO has been added, e.g., in order to dry the polymer.

Preferably, the metal oxide to be used as water and smell scavenger, i.e. as a deodorant and as a drying agent, particularly the calcium oxide, is dispersed or in any case inserted in a polymer matrix compatible with the claimed polyolefin formulation, to form a drying compound, generally in the form of granules. The metal oxide drying agent, preferably CaO, represents at least the 20 wt % of the compound formed by the polymer matrix of the compound granule or pellet and the drying agent; more preferably the percentage of the calcium oxide, still by weight, is comprised between 40% and 50% of the total weight of the drying compound. The drying compound, made of polymer and metal oxide, preferably calcium oxide, is present in the final mixture, ready to be used in the extrusion or injection molding process, in a range comprised between 0.4% and 20%, preferably 0.5% and 20%, more preferably between 1% and 12%, by weight relative to the total weight of the mixture.

Drying compounds of such a kind as above discussed are easily produced and are also available on the market, from manufacturers and/or dealers of masters and additives for polymer molding, such as stabilizing, dispersing and release agents. The polymer matrix usually is PP or PE.

The amount of metal oxide such as CaO to be used in order to absorb and neutralize the bad smell, increases with the increase of the percentage of the polyolefins from recycled packaging coming from food industry, and/or with the increase of the percentage of PVdC present in the recycled flake, or granule, usually used in packaging and container manufacturing for highly aromatic (odorous) foods, or of styrene polymers, in the form of PS, usually used for the manufacturing of packaging and containers for perishable foods.

A further object of the invention is a method of manufacturing products from a polymer mixture containing recycled packaging polymers, wherein said mixture has a weight percentage amount of the PP and PE polyolefin components, in the different forms they display, equal to at least 80% of the total weight of the mixture, a maximum content of PA (polyamides) of 1 wt % of the total weight of the mixture, a maximum PET content of 1 wt % of the total weight of the mixture, a maximum content of PVC, PVdC, and styrene polymers of 20%; characterized in that at least one of CaO, MgO, Al₂O₃, ZnO, preferably CaO and MgO is added to said mixture, before or during a molding step of the same, at an amount comprised between 0.1-10% by weight, preferably 0.1 wt % to 8.0 wt % relative to the total weight of the mixture. In the polyolefin product derived from recycling, some impurities are found, generally at an amount in the order of 1.0-2.0 wt % on the total weight of the material. These impurities are comprising organic materials, including nitrogen based materials, that are believed to be responsible for the production of bad smell in injection molding and in extrusion steps. The applicant believes that the metal oxides before or after they have reacted with water, act as a scavenger of the organic molecules, thus reducing or removing the smell from the materials.

Use of the claimed metal oxides according to claim 18 or 19 is an object of the invention. Another object of the invention is a recycling method according to claim 20.

A preferred metal oxide is CaO; a mixture of CaO and other oxides can be used. Further drying agents can be added, such as CaCl₂, CaSO₄ and other drying agents. The molding step is preferably an injection molding step or an extrusion molding step. If present, ZnO is preferably used in combination with CaO or MgO.

Through the researches carried out, the applicant found that the above mentioned metal oxides, preferably CaO and MgO, most preferably calcium oxide CaO, preferably added in the form of a compound containing the oxide in a polymer matrix carrier, performs effectively and efficiently the following activities.

The mentioned oxides CaO, MgO, Al₂O₃, ZnO, preferably CaO and MgO CaO, are able to extract and “absorb” the intrinsic humidity of polyolefin granules or flakes obtained from recycled packaging, whereas the conventional dehumidification and drying processes in silos, preliminary to the molding step, as already said above, show to be ineffective to achieve such an object, even by using silica gel within the dryers.

Thanks to the use of calcium oxide CaO or at least one of the mentioned drying metal oxides, the production molding process is essentially odorless, as well as the manufactured products, at the end of the cooling process; it has been verified that such artifacts are completely and permanently odorless at the end of the shrinkage and crystallization processes following the molding. Thus, CaO and the other oxides proved to be effective also as deodorant. Moreover, they carry out an optional biocidal and bio-stabilizing function on the flake or the granule coming from recycled packaging contaminated by organic material.

Finally, the mentioned oxides, in the specific form of drying compounds based on at least one of CaO, MgO, Al₂O₃, ZnO, preferably CaO and MgO, do not present detrimental effects on the molds which are not affected by corrosion and wearing processes; similarly, they have no harmful effects on the environment and health, during the injection molding processes or incineration at the end of the product's life. Drying effects similar to those above described (not including the deodorizing effect) can be obtained also starting from calcium chloride CaCl₂ or calcium sulphate CaSO₄, again they should be vehiculated in the final polymer mixture, in the specific form of drying compounds based on calcium chloride or sulphate in a polymer matrix (carrier). However, the use of CaCl₂ or CaSO₄ could result in corrosion problems of the molds.

The polymer mixture or formulation according to the invention is present, in an embodiment, in the form of a physical mixture of granules or flakes of thermoplastic materials (polyolefin material) as described above, and of a drying compound containing one of the claimed oxides in a compatible carrier, preferably a polyolefin polymer carrier.

In a preferred embodiment the drying agent, particularly in the form of granules of polyolefin material containing CaO in the percentages indicated above, is mixed with the mixture in the form of a granule or flake from recycled packaging in the needed amount and is extruded or drawn at a temperature comprised between 60 and 300° C., preferably in the range 80-240° C., more preferably 80-180° C. or 90-180° C. At low temperatures, granules of the product ready to be injected, molded or extruded are obtained, the product containing calcium oxide homogeneously distributed within the recycled polymer guarantees results superior to those achievable with the simple physical mixing of powder and polymer materials set forth above. The amount of hydroxides in the granules depends on the temperature at which the granulation extrusion is carried out.

What has been mentioned above refers to the mixture before its use for the molding of the desired manufacture product; such a mixture is an object of the present invention.

It is believed that the metal oxides are activated by heating them, namely by the heat of the molding process, such as injection molding. The activated oxides react with water contained in the polymers, especially recycled polyolefin polymers, to provide corresponding hydroxides; said hydroxides, e.g. Ca(OH)₂, are therefore a telltale and an evidence that the invention process has been used.

As discussed, a further object is a method for the manufacturing of products starting from the mixture of the invention, by means of a molding step of the mixture, particularly by injection molding. The so obtained products, i.e. the products that can be obtained by the molding process of a mixture of the invention, are a further object of the invention.

With the term “products that can be obtained by the molding process of the invention” it is meant to represent all obtainable product types, such as injection-molded finished pieces. Without limiting the object of the invention, the applicant believes that the temperatures reached during the molding process lead to the dissolution of the granules containing the drying agent thereby releasing the CaO, and that under the mixing action (e.g. of the screws) in the molding apparatus the CaO contacts the humidity present within the polymer material. Probably the CaO reacts and forms Ca(OH)₂. As a consequence, the products that can be obtained by the process of the invention can be characterized by the presence of CaO and/or Ca(OH)₂; in particular, Ca(OH)₂ will be present in the finished manufactured product, as well as CaO at a residual degree, if any, in amounts clearly lower than those in the initial mixture before molding. The scope invention includes a formulation before and after the oxides have acted on humidity and have suppressed the smell, if any.

A specific claim of the present invention is also the determination of an effective drying method of granules and flakes from polyolefin recycled packaging, method that could already be used at the end of the industrial process of regeneration, particularly where the granule production is intended. Presently, manufacturers of flakes or granules from recycled packaging do not carry out this operation of combined extrusion (drawing/granulation) with a drying agent based on the claimed metal oxides, in particular calcium oxide; at most they carry out a final extrusion (drawing) with a mineral filler of calcium carbonate CaCO₃, in an amount usually comprised between 1% and 25% of the total weight of the final obtained granule, but sometimes even at higher percentages, in order to achieve a hardening of the known material that, as mentioned, is very rubbery and soft.

This is done on specific customer's request. Not to compromise efficient injection molding, the effective percentage of calcium carbonate that can be added to achieve rigidity must be, in any case, compatible with the low MFI that the granule itself already possesses and that is further reduced by the CaCO₃ mineral filler. An excess of CaCO₃ mineral filler may in addition induce an unwanted fragility. In the above presentation of the components of the polyolefin granule or flake from recycled packaging, this possible hardening of the granule has been ignored for sake of simplicity, by leaving this possibility to the molder who can perform this step, if desirable and possible.

On the contrary, in a scenario of the present invention, the manufacturer of the polyolefin granule from recycled packaging could directly add to the polymer material the drying compound based on calcium oxide, as well as add the CaCO₃ mineral filler, where desirable and possible, and proceed with a combined drawing, i.e. extrusion and granulation for pellet production. The molder carrying out the injection molding process can in this case directly use the so re-elaborated granule, and possibly perform only the dehumidification and preliminary heating within the silos, after the color masterbatch has been added to the mixture and, possibly, other usual additives such as release agents.

If the molder is provided with an extruder, the same could perform the extrusion of the drying agent based e.g. on calcium oxide within the polyolefin granule from recycled packaging (also with the possible addition of the CaCO₃ mineral filler), preferably by drawing at the same time the color masterbatch too, and, possibly, the release agents, then proceeding with the dehumidification and heating within the silos, before the injection molding.

This final drawing assures the achievement of the optimal result, without any demixing event during the injection molding, e.g. because of uneven distribution of the drying agent and the color masterbatch within the mixture, due to the different specific weights of the polyolefin granule from recycled packagings, of the drying agent based on the claimed metal oxides and of the color masterbatch.

A typical composition of a first family of formulations based on a polyolefin granule or flake from recycled packaging provides the use by weight of 0.5-20% of the metal oxide (i.e. drying agent, or scavenger) compound based on at least one drying agent selected from CaO, MgO, Al₂O₃, ZnO, to give a total CaO (or equivalent drying agent) amount comprised between 0.1 wt % and 8.0 wt % with respect to the total weight of the mixture. The mixture according to this embodiment further comprises the following weight amounts relative to the whole mixture: 0-25% of CaCO₃ mineral filler, 55-99.5% of not filled polyolefin material from recycled packaging, i.e. 55-99.5% by weight without counting in said weight the amount of CaCO₃ mineral filler that may be present, and subjected to all the limitations of polymer composition/formulation set forth above. The percentage of the color masterbatch, as well as that of the release agent and other additives, is not taken into account in the here disclosed formulation, and is considered a separate addition in amounts known per se, which are not an object of the present invention.

Finally, the CaCO₃ mineral filler can be replaced with a filler based on talc, or with a filler based on glass fiber. This is valid also for the additional formulation families that will be disclosed in the following.

Wood in the form of particles, suitable for injection molding processes, can also be used. In case of wood use, the amount of the filler can reach 20 wt % of wood relative to the whole formulation weight, i.e. the amount of wood in the formulation is comprised between 0-20 wt %. In case wood is used as a filler, its addition to the formulation leads to a corresponding reduction of the CaCO₃, or talc, filler, or glass fiber filler, and/or of the amount of the polyolefin flake or granule from recycled packaging. Even in case of wood filler in the final mixture, the final extrusion-drawing of the mixture is preferable in order to achieve the desired results. It is also suggested to add the color masterbatch during the extrusion, in order to avoid demixing problems.

In the present description and examples, reference is be made to CaO, without limiting by this reference the scope to CaO only; as above mentioned, the invention relates to at least one metal oxide selected from CaO, MgO, Al₂O₃, ZnO, preferably CaO, MgO, most preferably CaO. ZnO, if present, is generally in combination with CaO.

The simple addition of calcium oxide to the quoted materials produces a first formulation family wherein the final mixture comprises 55-99.5% of polyolefin material from recycled packagings, which has been mixed with a drying agent based on calcium oxide or another of the mentioned oxides, to give a total amount of the above quoted metal oxides comprised between 0.1 to 10 wt % preferably 1.0% to 8.0 wt % with respect to the total weight of the mixture. In the recycled polyolefin product, impurities due to the recycling are found, generally in an amount of the order of 1.0-2.0 wt %. Here as well as in the other formulations of the invention, the percent of CaO and/or other claimed metal oxides on the total weight of the mixture is such as to remove water from the polymer and prevent smell forming in the molding process; the amount preferably is in the range of 0.1% to 10%, preferably 0.1% to 8.0% by weight of the total formulation.

In this formulation family, the polyolefin content in the polymer fraction is, as seen, greater than 80% of the total weight of the contained polymers from recycling; the amount of PP from recycling, contained in any form within the material, is present in a weight ratio relative to the PE from recycling up to a minimum of PP/PE=20/80. In order to have a ratio PP/PE=20/80, the PE must have a sufficiently high content of HDPE in order to guarantee the mechanical properties of the end product. Also the HDPE preferably derives from recycling. On the contrary, the PP/PE ratio can reach a maximum of 95/5 particularly if HDPE is absent in the PE component.

The products that can be obtained with the formulations of this family have simple forms, meaning that the volume, surface, and thickness of the product allow a substantially non-turbulent injection flow, and that they are essentially of aesthetic nature, i.e. do not involve technical-functional requisites to guarantee the possibility of carrying out translations and/or rotations movements.

With such a formulation an end product is obtained such as, for example, a furniture element, with aesthetically valuable surfaces, characterized by the absence of scarfing, marks, rings caused by humidity, and provided with the technical-functional features sufficient to guarantee its safe use by the end-user, and its certification according to the technical regulations of the field such as, e.g., the UNI-EN.

A second formulation family suitable to obtain aesthetic products, suitable also for large-scale use, comprises in the final mixture virgin polypropylene homopolymer PP and also, possibly, polypropylene copolymer PP. The percentage amount of polypropylene homopolymer to be added depends on the peculiar complexity of the chemical composition of polyolefin flake or granule from recycled packagings. In any case, the polyolefin components from recycling must be at least 80 wt % of the granule obtained from recycling, or of the flake from recycling. The polyamides PA from recycling, as well as the PET from recycling, are both present in an amount not greater than 1% of the total weight of the recycled flake or the granule itself.

The virgin homopolymer PP (or the copolymer) acts as a “binder”, or a “compatibilizer” of the different polymer components, particularly in the presence of polymer components with low mutual compatibility, relative to the injection molding process, and as a “fluidizer” of the mixture in the injection molding process. It is particularly by acting on the MFI of the virgin homopolymer PP that the MFI (g/10 min, ASTM1238L) of the final mixture to be used in the injection molding process is controlled.

The virgin homopolymer PP to be used will have a MFI in the range between 10 and 50 (g/10 min, ASTM1238L), depending on the specific objects to be achieved, on the actual polymer composition and on the starting MFI of the available polyolefin flake, or granule, from recycled packagings, as well as on the need of rigidity by using the CaCO₃ mineral filler. The optimal MFI of the virgin homopolymer PP to be used in this formulation family is 25. The formulation family proposed in the following satisfies the economic restriction laid down at the beginning among the objectives the invention pursues, i.e. to be competitive with respect to traditional formulations based on virgin PP charged with CaCO₃ mineral filler.

The typical composition of this second formulation family based on polyolefin granule or flake from recycled packagings provides the use by weight of 0.5-20.0% of polymer compound containing calcium oxide CaO (to give 0.1% to 10%, preferably 0.1% to 8.0% of CaO in the final mixture); 0-25% of CaCO₃ mineral filler; 8-98.5% of polyolefin granule (not considering any CaCO₃ or other mineral filler) from recycled packaging, and subjected to all limitations for polymer formulation that have been disclosed above; 1-80% of virgin homopolymer PP. The preferred MFI for the homopolymer PP is 25 (g/10 min, ASTM1238L), but with a possible variation between 10 and 50, with reference to the above mentioned specific parameters. Here as well as in the other formulations of the invention, the percent of CaO and/or other claimed metal oxides on the total weight of the mixture is preferably in the range of 0.1% to 8.0% before the formulation is subjected to heat treatment, namely extrusion to provide pellets or extrusion or injection molding to provide a final molded product (e.g. furniture elements, automotive elements, etc.). As mentioned, the total amount by weight of the claimed oxides, if any, and corresponding hydroxydes expressed as oxides, is preferably in the range of 0.1%-10% preferably 0.1% to 8.0% by weight.

The percentage of the color masterbatch, as well as that of the release agent and other additives, is not taken into account in the disclosed formulation, and is considered as a separate subsequent addition.

The final drawing of the mixture, comprising the color masterbatch and the release agent, is recommended in order to avoid demixing, as already set forth above. Following the extrusion-drawing step, dehumidification and heating in silos are recommended, as a preparation to the real use in the molding step.

As already highlighted above, the mineral filler is preferably selected from CaCO₃, talc, and glass fiber. Wood in the form of particles suitable for the injection molding processes can be used as a filler at an amount up to 20 wt % of wood relative to the whole formulation. The above remarks for the wood filler in the previous family are also valid for this one.

As said above, this second formulation family may also comprise the presence of virgin copolymer PP, if it is required by the specific nature of the object to be molded, such as a peculiar elasticity or impact resistance. In these specific cases, the introduction of virgin copolymer PP occurs at the expense of the defined percentage of the virgin homopolymer PP.

Therefore the complete description of this family of formulations, i.e. compositions, provides for the possible presence of virgin copolymer PP, with a MFI comprised between 10 and 50 and preferably 20-30, more preferably 25 (g/10 min, ASTM1238L). The possible presence of the virgin copolymer PP in this second formulation family, that replaces the presence of the virgin homopolymer PP, is 0-40%.

Summarizing, the preferred formulation of a second polymer family from recycling, comprising a drying agent that is preferably CaO, is the following (the percentages are by weight on the final formulation weight):
0.5-20% of polymer compound, containing at least one of CaO, MgO, Al₂O₃, ZnO calcium oxide CaO, providing 0.1 to 10.0% of said metal oxides and/or an amount of their hydroxides, the total amount by weight of the claimed oxides, if any, and corresponding hydroxydes expressed as oxides, is 0.1% to 10%, preferably in the range of 0.1% to 8.0% by weight.
   0-25% of mineral filler selected from CaCO₃, talc, glass fiber and wood (if wood max. 20%),
   8-98.5% of polyolefin material from recycled packaging, any filler being excluded from the percent evaluation
   1-80% of virgin homopolymer PP with a MFI comprised between 10 and 50 (g/10 min, ASTM1238L)
   0-40% of virgin copolymer PP, with a MFI comprised between 10 and 50 (g/10 min, ASTM1238L),
   with the proviso that the total amount of virgin homopolymer and copolymer PP is not greater than 80 wt % and that the amount of wood is not greater than 20 wt %.

As already mentioned, the polymer compound contains at least 20 wt % of the drying agent; more preferably, the percent of calcium oxide, or other oxide, by weight, is in the range between 40% and 50% of the total weight of the drying compound. The drying compound, made of polymer and drying agent, preferably calcium oxide, is present in the final mixture, ready to be used in the extrusion or in the injection molding process, in a range comprised between 0.4% and 20%, preferably 0.5% and 20%, more preferably between 1% and 12%, by weight relative to the total weight of the mixture. Alternatively, the metal oxides could be introduced into the mixture after

Also this second formulation family is, on the whole, economically competitive with respect to the traditional formulations based on virgin PP charged with CaCO₃ mineral filler, due to purchasing costs of the polyolefin flake, or granule, from recycled packaging set forth at the beginning, and because the drying agent based on calcium oxide is itself a cheap drying additive, with a purchasing price comprised between 1.0 and 3.0 euro/Kg, depending on the CaO concentration in the drying agent itself, and on the overall quality of the drying agent; clearly, the percentage of the used drying agent itself is reduced as the percentage comprised in the final mixture of the polyolefin flake or granule from recycled packaging is reduced. In a further preferred embodiment of the invention, the virgin homopolymer PP (and in case also the virgin copolymer PP) used in the final mixture have a high modulus, i.e. they have an elastic modulus higher than 1500 N/cm², but in the range between 1700 and 2300 N/cm² (with 2100 N/cm² as typical value). The possible presence of the high modulus virgin copolymer PP is at the expense of the high modulus homopolymer PP, i.e. an increase in copolymer results in a decrease of the homopolymer.

The introduction of this third formulation family is accounted for because the technical performances, in particular those related to the load capacity, to the ability of such families to withstand an impact shock, to sustain the impact of deforming forces, and to sustain the loading and wearing processes, due to the specific conditions of use, is greater than that obtainable with the use of traditional mixtures based on virgin PP charged with CaCO₃ mineral filler, and can be pursued with costs lower than those of traditional mixtures, or with only slightly higher costs. This last formulation family is particularly useful to obtain products of technical nature, components that cause translation and rotations, parts that should be assembled with joints, or with hardware use.

The typical composition of this third formulation family, based on polyolefin granule or flake from recycled packaging, makes use of an effective amount of at least one of CaO, MgO, Al₂O₃, ZnO, preferably calcium oxide CaO, with the above mentioned composition, to provide 0.1 to 8.0% of said at least one of CaO, MgO, Al₂O₃, ZnO in the initial formulation and/or a corresponding amount of their hydroxydes in the formulation after reaction of the oxides with at least water (preferably added in the form of a compound); 0-25 wt % of CaCO₃ mineral filler; 8-98.5 wt % of polyolefin granule from recycled packaging not filled with CaCO₃ mineral filler, and subjected to all the limitations for the polymer formulation that have been discussed for the second formulation family; 1-80 wt % of high modulus virgin homopolymer PP (modulus within the range of 1700 N/cm² to 2300 N/cm², typical modulus 2100 N/cm²), with a typical MFI of 25, but with the possible variation between 10 and 50, with reference to the specific parameters already mentioned for the second formulation family. The percentage of the color masterbatch, as well as that of the release agent and other additives, is not taken into account in the present formulation, and is considered as a separate subsequent addition. Final drawing of the mixture, comprising the color masterbatch, and the subsequent dehumidification, are recommended.

The filler is preferably selected from CaCO₃, talc, glass fiber and wood. In case of wood use, the filler amount can reach 20 wt % of wood relative to the whole formulation. In case of wood use as filler, the weight percentage contribution in the final mixture of the filler of calcium carbonate or glass fiber, or talc, and of the polyolefin flake or granule from recycled packaging, will be correspondingly reduced, by distributing this percentage reduction in a suitable way among the other different components, with reference to the specific objects to be obtained by injection molding. As previously mentioned, this third formulation family can also comprise high modulus virgin copolymer PP (modulus in the range between 1700 N/cm² and 2300 N/cm², typical modulus 2100 N/cm²), if required by the specific nature of the product to be molded, e.g., where a further increase in the deformation resistance, or a further increase in the impact resistance, is required. In these specific cases, the introduction of the high modulus virgin copolymer PP occurs at the expense of the defined percentage of the high modulus virgin homopolymer PP. Therefore the complete description of this third formulation family considers the possible presence of high modulus virgin copolymer PP, with a typical MFI of 25, with possible variation of the MFI itself between 10 and 50, with reference to the specific molding conditions, and to the specific manufactured product to be molded, at the expense of the high modulus virgin homopolymer PP, as mentioned. The possible percentage contribution of the high modulus virgin copolymer PP to this second formulation family, at the expense of the percentage contribution of the high modulus virgin homopolymer PP, is 0-40%.

Typically, the composition of the third family contains the following amounts by weight:
0.5-20% of a drying compound including at least one of CaO, MgO, Al₂O₃, ZnO and/or a corresponding amount of their hydroxides to provide 0.1 to 10.0%, preferably 0.1 to 8.0%, preferably containing calcium oxide CaO, the total amount by weight of the claimed oxides, if any, and corresponding hydroxides expressed as oxides is preferably in the range of 0.1% to 8.0% by weight,
0.0-25% of mineral filler selected from CaCO₃, talc, glass fiber and wood (if wood max. 20.0%),
8-98.5% of not filled polyolefin granule from recycled packaging,
1-80% of virgin homopolymer PP with a MFI in the range between 10 and 50 (g/10 min, ASTM1238L) and with a modulus in the range between 1700 N/cm² and 2300 N/cm²,
0.0-40% of virgin copolymer PP with a MFI comprised between 10 and 50 (g/10 min, ASTM1238L) and with a modulus comprised between 1700 N/cm² and 2300 N/cm²,
provided that the total amount of virgin homopolymer and copolymer PP is not greater than 80 wt % and that the amount of wood is not greater than 20 wt %. Concerning the drying compound containing CaO, the observations given above apply also here.

Within the scope of the present invention are comprised all the mixed formulations that can be obtained starting from the second and the third family, with the combined use of standard high modulus virgin homopolymer PP, as well as, where needed and still at the expense of the standard high modulus virgin homopolymer PP, of standard high modulus virgin copolymer PP, within the general limits, for the virgin homopolymer PP and for the virgin copolymer PP, previously already described. All the formulations comprising HDPE fall within the scope of the invention.

According to an aspect of the invention, a whitening, i.e. bleaching, step (and a subsequent drying step) is carried out on the polymeric material before it is admixed with the drying metal oxides. Preferred whitening agents are percarbonates and hydrogen peroxide, preferably percarbonates.

1. A polymer formulation, comprising the following amounts by weight on the total weight of the formulation:
at least one metal oxide selected from CaO, MgO, Al₂O₃, ZnO and/or their corresponding hydroxydes, wherein the total amount of metal oxides and their corresponding hydroxides, when expressed as oxides, is in the range of 0.1-10 wt % on the total weight of the mixture,
0-25 wt % of mineral filler selected from CaCO₃, talc, glass fiber, and wood,
8.0-99.9 wt % of polyolefin material from recycled packaging,
wherein said polyolefin material comprises at least 80 wt % of PP and/or PE, a PA amount between 0 and 1.0 wt % and a PET amount between 0 and 1.0 wt %,
polyolefin materials not from recycled packaging up to achieve 100%.

2. A polymer formulation according to claim 1, wherein said at least one metal oxide includes at least CaO and wherein the total amount of metal oxides and their corresponding hydroxides, when expressed as oxides is in the range between 0.2 and 6.0 wt % on the total weight of the formulation.

3. A formulation according to claim 1, wherein said at least one metal oxide is in the form of a compound containing at least 20 wt % of said at least one metal oxide.

4. A polymer formulation according to claim 1, wherein said polyolefin material further comprises up to a maximum of 20 wt % of polymers selected from PVC, PVdC and styrene polymers.

5. A polymer formulation according to claim 1, comprising the following weight amounts:
55.0 wt %-99.5 wt % of polyolefin material from recycled packaging.

6. A polymer formulation according to claim 1, comprising the following weight amounts:
8.0-98.5 wt % of polyolefin material from recycled packaging,
1-80 wt % of virgin homopolymer PP with a MFI in the range between 10 and 50 g/10 min
0-40 wt % of virgin copolymer PP, with a MFI in the range between 10 and 50 g/10 min,
with the proviso that the total amount of virgin homopolymer and copolymer PP is not greater than 80 wt % and that the amount of wood present is not greater than 20 wt %.

7. A polymer formulation according to claim 1, including the following weight amounts:
8 wt %-98.5 wt % of polyolefin granule from recycled packaging,
1 wt %-80 wt % of virgin homopolymer PP with a MFI comprised between 10 and 50 g/10 min and with a modulus in the range between 1700 N/cm² and 2300 N/cm²,
0.0-40 wt % of virgin copolymer PP, with a MFI comprised between 10 and 50 g/10 min, and with a modulus in the range between 1700 N/cm² and 2300 N/cm², with the proviso that the total amount of virgin homopolymer and copolymer PP is not greater than 80 wt % and that the total amount of filler is not greater than 20 wt % if it is wood.

8. A formulation according to claim 3, wherein the amount of said drying compound is comprised between 0.5 wt % and 20 wt % relative to the total weight of the formulation relative to the total weight of said formulation.

9. A formulation according to claim 1, which is in the form of granules containing said polyolefin material or polyolefin materials and at least one metal hydroxide selected from the reaction products of at least one of CaO, MgO, Al₂O₃, ZnO.

10. A method for manufacturing products from a polymer mixture containing recycled polymers, wherein said mixture is subjected to a heating step, characterized in preparing a polymer mixture that has the following composition:
0-25 wt % of mineral filler selected from CaCO₃, talc, glass fiber and wood,
8.0-99.9 wt % of polyolefin material from recycled packaging wherein said polyolefin material comprises at least 80 wt % of PP and/or PE, a PA amount between 0 and 1.0 wt % and a PET amount between 0 and 1.0 wt %,
and wherein at least one metal oxide selected from CaO, MgO, Al₂O₃, ZnO is added to said mixture before or during said step of extrusion or injection molding, said at least one metal oxide being added in an amount effective to remove water and smell from the said polyolefin material.

11. A method according to claim 10, wherein said at least one metal oxide is added in an amount in the range between 0.1 wt %-10 wt % wt % on the total weight of the mixture.

12. A method according to claim 10, wherein said at least one metal oxide is added to said polymer mixture in the form of a compound including said metal oxide and a polymer carrier compatible with said polyolefin material, the amount of said compound being in the range between 0.5 wt % and 20 wt % on the total weight of the mixture,

13. A method according to claim 10, wherein said at least one metal oxide is selected from CaO and MgO.

14. A method according to claim 10, wherein the said molding step is an injection molding step.

15. A method according to claim 10, wherein in said heating step the mixture is heated at a temperature in the range of 60 to 300° C. to react said at least one metal oxides at least with water present in said polyolefin material.

16. A molded product as obtainable from the method according to claim 10, containing at least one metal hydroxide resulting from reaction with water of an oxide selected from CaO, MgO, Al₂O₃, ZnO, wherein the total amount of hydroxides and of their corresponding metal oxides, if present, when expressed as oxides, is in the range of 0.1-10 wt % on the total weight of the mixture.

17. A product according to claim 16, wherein said molded product is selected from furniture devices, including chairs, tables, armchairs, deck chairs, food carts, closed and open elements for the storage of household products and tools, toys, cabins for parks and gardens; automotive elements including door panels and interior and external elements including dashboard and structural elements.

18. (canceled)

19. (canceled)

20. A method of recycling thermoplastic polymeric materials, characterized in comprising the steps of adding to said materials at least one metal oxide selected from CaO, MgO, Al₂O₃, ZnO, to remove water and smell from the said material and in subjecting the added materials to an increase in temperature.

21. A method according to claim 20, further comprising a step of bleaching said polymer material.
